(19) United States
(12) Patent Application Publication
(10) Pub. No.: US 2025/0216222 A1
(43) Pub. Date: Jul. 3, 2025

(54) SENSOR DATA VERIFICATION

(71) Applicant: Intel Corporation, Santa Clara, CA (US)

(72) Inventors: Robert Watts, El Dorado Hills, CA (US); Sarat Chandra Poluri, Phoenix, AZ (US); Stanley Mo, Portland, OR (US); Rene J. Sanchez, Hillsboro, OR (US); Steven Krebs, Maricopa, AZ (US); Julia Scott, Salt Lake City, UT (US)

(21) Appl. No.: 18/397,142

(22) Filed: Dec. 27, 2023

(51) Int. Cl. G01D 5/244

(52) U.S. Cl. CPC G01D 5/24476; G01D 5/24428

(57) ABSTRACT

System and techniques to verify sensor data are described herein. When sensor data is received, the sensor data is recorded into a data store and a trust score is generated for at least a portion of the sensor data. The trust score is based on several factors including a measure of agreement between the sensor data and other sensor data of a scene. The trust score may then be used to measure the veracity of claims supported by the sensor data.

### BACKGROUND

Sensors are widely utilized in modern computer systems and electronics to detect and quantify real-world phenomena such as heat, light, sound, pressure, motion, and other physical properties. Signals from sensors provide input data to a system's processor and software enabling analysis and responsive functions. Common sensor devices implemented in computing devices and consumer electronics include microphones to capture audio input, cameras to acquire images and video, touch screens to detect user input by finger contact, accelerometers and gyroscopes to measure motion and orientation, and temperature probes to monitor system heat dissipation. Such sensors translate observed environmental phenomena and parameters into electrical signals through transduction mechanisms. The generated signals may use analog-to-digital conversion to render the information in a digital format consumable by computerized components. The background and proliferation of sensing devices in electronics and computing equipment has enabled expanded capabilities driven by real-time environmental data.

Artificial intelligence (AI) refers to computational systems designed to exhibit qualities of natural intelligence and perform tasks commonly associated with intelligent beings. Research into AI has explored diverse approaches including machine learning, neural networks, reinforcement learning, computer vision, natural language processing, robotics, and expert systems. These techniques may enable machines to learn behaviors, patterns, or insights without being explicitly programmed for specific tasks. By analyzing large datasets, models may derive predictive capabilities or make data-driven decisions or recommendations. The models may be configured to perform computer vision, speech recognition, or translation. Some AI systems have achieved human-level performance across select cognitive tasks leading to a proliferation of AI solutions for automated perception, reasoning, planning, creativity, and problem solving.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for sensor data verification, according to an embodiment.

FIG. 2 illustrates an example of a data flow to capture data from sensors, according to an embodiment.

FIG. 3 illustrates an example of a data flow to establish a trust score for data captured from a sensor, according to an embodiment.

FIG. 4 illustrates a flow diagram of an example of a method for sensor data verification, according to an embodiment.

FIG. 5 is a block diagram illustrating an example of a machine upon which one or more embodiments may be implemented.

### DETAILED DESCRIPTION

AI techniques present promising capabilities for automated generation of synthetic data that mirrors real-world sensor outputs across modalities. AI systems are often trained on digital corpora of text, imagery, audio, or video, to contain meaningful representations of this data to produce simulated analog or digital sensor measurements. For instance, AI models may generate time-series temperature data fluctuating within expected ranges, pixel outputs forming recognizable images, or audio waveforms comprising identifiable sounds. Despite limitations in accuracy compared to physical instrumentation, advances in few-shot learning—where few-shot learning is a technique in which a small number of examples are used as training data—conditional generation, or domain adaptation continue to enhance the fidelity of AI-fabricated data. As techniques improve, the ability to automatically synthesize plausible surrogate sensor data at scale may facilitate testing, validation, or augmentation of data-driven systems relying on such inputs. Applications in simulated environments for autonomous vehicles, medical devices, Internet-of-Things (IoT) systems, or robotics benefit from these advances. However, an issue arises in transparency and responsibility of labeling and usage of synthesized data; it is not always clear if data represents reality or an AI-assisted manufactured reality.

It is increasingly hard to distinguish real data from synthetic (e.g., faked, manufactured, simulated, spoofed, etc.) data in the current technological landscape. There are many scenarios where establishing the ground truth is important to determine accurate situational awareness decisions. Live sensor data (e.g., video, infrared (IR), audio, lidar, etc.) is among the most valuable and complex of datatypes and this sensor data is increasingly vulnerable to being faked. It may be very difficult to detect such counterfeit sensor data, especially when the counterfeit sensor data is produced by generative AI, for example. As the number of sensor-capable endpoints increases—and thus consequently the volume of sensor data accelerates—opportunities to fake or manipulate this sensor data become more prevalent. Some attempts, such as timestamping, watermarking, or hashing of coded time, data, or location information into the data (e.g., image, stream, etc.) have been used to verify that the sensor data came from a particular source (e.g., a particular camera) is unadulterated (e.g., unmodified). However, these approaches generally involve modifying the sensor data content and may work only in relatively static environments.

To address the issue of synthetic data, an automated and transparent (e.g., verifiable) system for verifying data veracity is described herein. This system uses a trust vector for sensor data. The trust vector may be measured against multiple sensors in a scene to determine the validity of sensor data that is being verified. These techniques may operate in both online (e.g., real time) and offline (e.g., batch) modes. Generally, data inputs from a given scene at a given time period may be recorded and tagged with trust vectors in near-real-time in the online mode. Also, data alleging to be from the same scene may be compared with an immutable record from other sensors and likewise tagged with a trust vector in the offline mode. The consensus-based technique of comparing sensor data from across (e.g., over) a scene and producing trust vectors of the analyzed data improves data trustworthiness and provides a verifiable manner to dispute spoofed or modified sensor data. Additional details and examples are provided below.

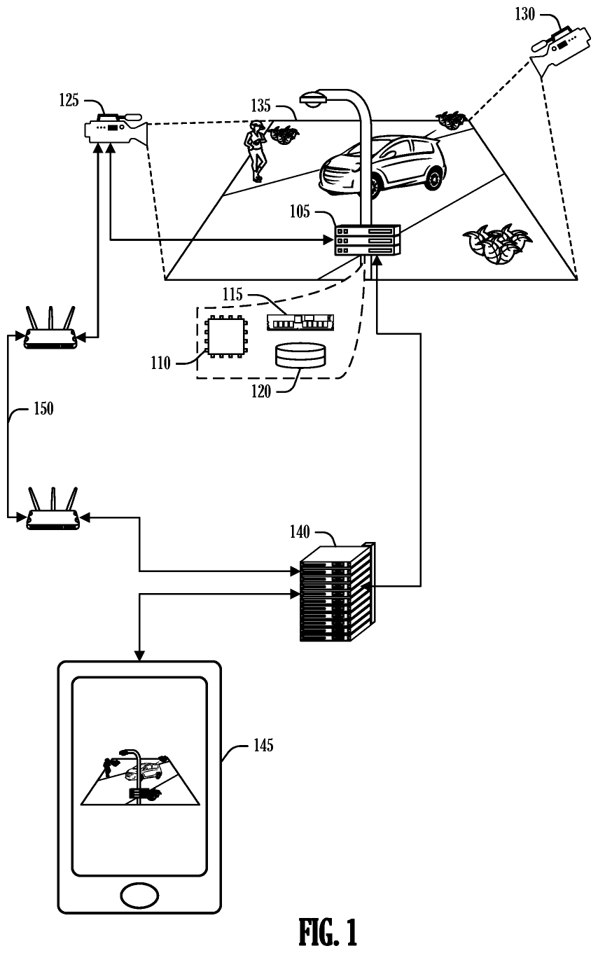

FIG. 1 is a block diagram of an example of an environment including a system for sensor data verification, according to an embodiment. The system includes multiple sensors—such as the camera 125 and the camera 130—with a view of a scene 135. There is an “edge” compute node 105 located close to the sensors and the scene 135. The compute node 105 is connected to a computer 140 that is connected to a tablet 145. The compute node 105 includes processing circuitry 110 (e.g., a central processing unit (CPU), graphics processing unit (GPU), field programmable gate array (FPGA), or the like), storage 120 (e.g., non-volatile memory such as a hard drive, solid state storage, storage class memory, etc.) and working memory 115 (e.g., volatile memory such as random access memory (RAM) used to hold a working state of the compute node 105 when in operation).

For clarity, the following examples are generally described from the perspective of the camera 125 being the sensor to produce the sensor data of the scene and the processing circuitry 110 of the compute node 105 being configured (e.g., hardwired, by software in the working memory 115 or the storage 120, or a combination of any of these elements) to perform the active aspects of the technique. Accordingly, the processing circuitry 110 is configured to receive (e.g., via a network interface of the compute node 105) a communication that includes first sensor data from a sensor (e.g., the camera 125). Here, a portion of the first sensor data pertains to the scene. That is, this portion of the first sensor data represents a measurement made by the sensor of the scene 135.

In an example, the scene is defined by space and time (e.g., attributes of each). It is typical to define the scene 135 by space (e.g., a volume, area, etc. rather than the absence of something), as well as perspective (e.g., what is viewable or measurable by a given sensor); however, here the scene is also defined by a period of time (e.g., a start and an end time). In an example, space is defined by physical dimensions of a subject, such as a road length as illustrated, a building front, a highway exit, etc. In an example, space is as a subset of the first sensor data. In this example, the space may be less than is observed by the sensor. For example, the space may be the vehicle, as illustrated, while the camera 125 also captures data about the person, the light pole, and the foliage. Thus, the space that is part of the definition of the scene 135 may correspond to a proper subset of the sensor data. Also, consider a scenario where the camera 125 sweeps from side-to-side. Different segments of video captured may correspond to different spaces and different scenes.

In an example, the subset of the first sensor data is part of an image or a frequency band of audio or radio signals. This example narrows the previous example to a focus on frequencies of the human voice rather than all frequencies captured by a microphone, for example. Further, a portion of an image, such as the upper right quarter of the image, may correspond to the space that defines the scene 135. These subsets of the sensor data may enable more precise (e.g., higher resolution) comparisons of disparate sensor data when verifying the ground truth of a scene and evaluating the first sensor data with that ground truth.

In an example, an aspect of the subject is measured by the first sensor data. This aspect may be light transmission or reflectance, which is typical in visual light spectrum cameras, depth information (e.g., as measured by a depth camera), temperature, barometric pressure, sound, radio frequency (RF) transmissions, etc. This example acknowledges that many sensors capture a proper subset of scene aspects.

The processing circuitry 110 is configured to record the portion of the first sensor data in a data store (e.g., in the storage 120 or temporarily in the working memory 115). One benefit of the recordation involves retrieving the original first sensor data for later sensor data comparisons. In an example, the data store is an immutable data store. Here, immutable means that it is not feasible (or even impossible) to change the data in the datastore. Thus, in an example, the immutable data store prevents in-place modification of the first sensor data. In an example, the immutable data store uses a distributed ledger (e.g., blockchain) to enforce immutability. In an example, entries in the data store are encrypted to enforce immutability.

The processing circuitry 110 is configured to create a marker of the portion of the first sensor data by hashing a measurement of the portion of the first sensor data. This hash may use a cryptographic (e.g., one-way) hashing function. The measurement selected may vary but will often include aspects that are representative of the measurement. Thus, for example, all of the pixels of an image may be hashed. This entails a generally unique hash for the first sensor data with respect to hashes of other sensor data.

In an example, the portion of the first sensor data is determined by the time. In this example, the first sensor data is sliced based on the time to produce the portion of the first sensor data. These last examples use time to further quantize sensor measurements to enable more precise, or higher resolution, sensor data comparisons.

In an example, the marker is an entry in a vector. Here, a vector is an array of values where the position in the array has meaning. For example, a vector of three-dimensional cartesian coordinates may be defined as [x|y|z] to signify that the value in the first entry is the value of the x coordinate, the second entry corresponds to the y coordinate, and the third entry to the z coordinate. Accordingly, given two vectors for sensor data in the present system, comparing values at the same index involves comparing markers derived on the same measurement. In an example, other entries in the vector are other markers created from other portions of other sensor data that correspond to the space and the time of the marker created for the portion of the first sensor data.

The processing circuitry 110 is configured to receive second sensor data pertaining to the scene 135. In an example, the second sensor data is captured at the compute node 105. For example, the camera 130 may be part of the compute node 105 and generate the second sensor data of the scene 135. In an example, the compute node 105 records the second sensor data in the immutable data store. In an example, a second marker of the second sensor data is produced. These examples follow the procedure above for the first sensor data to illustrate the common way in which different sensor data is handled by the compute node 105 or the system generally.

The processing circuitry 110 is configured to compute a trust score for the second sensor data by comparing the second sensor data to the portion of the first sensor data stored in the data store. The trust score is a representation, usually numerical, of the degree of concurrence between different sets of sensor data. Thus, generally, sensor data that largely agrees with other sensor data receives a higher trust score. The way in which agreement occurs across modalities provides ample variety in trust score calculations. For example, determining that an audio recording corresponds to a video may involve matching sound samples with object recognition to determine, for example, that the sounds are consistent with an automobile collision that is identified in the video.

In an example, computation of the trust score includes a verification of the portion of the first sensor data in the data store based on the marker of the portion of the first sensor data. As noted above, the marker is generally a particular measurement of the sensor data that may be hashed or otherwise transformed. An example of marker validation may include taking an average luminance level in an image as the marker measurement and comparing it to the luminance level of another sensor data portion that corresponds in time and space. The more that these values agree, the greater the trust score for that element of the trust vector. Again, agreement with other data sources results in higher trust scores, however, these scores may be limited to the metrics that agree. Accordingly, in a 100-dimension vector, some markers may have high trust score values while others have low trust score values.

In an example, the computation of the trust score also includes a previous trust score computed for the portion of the first sensor data. Some trust score data may be computed when the sensor data is first captured (e.g., by the camera 125) and sent. This previous trust score data may often be considered as more likely true due to the proximity to the data generator. Thus, for example, the compute node 105, with a direct connection to the camera 125, may generate the previous trust score for a video clip, while the computer 140 is generating the current trust score for the same video clip. Note that the connection from the camera 125 is not direct to the computer, because the connection traverses either the compute node 105 or the network link 150. Such traversals increase the ability of a malicious actor to modify the underlying sensor data (e.g., to create synthetic sensor data). Accordingly, the previous trust score may be based on a context of the device upon receipt of the first sensor data. In an example, the context is at least one of time (e.g., how long ago was the sensor data captured) or distance (e.g., physical distance, network hops, devices traversed, etc.) between creation of the first sensor data by the sensor and the compute node 105. In an example, the context includes other sensor data received by the compute node 105 from other sensors that pertain to the scene 135.

In an example, the computed trust score may be provided (e.g., communicated, transmitted, held, etc.) by the compute node 105 to, for example, the computer 140 or the tablet 145, or another consumer of sensor data trust scores. The trust score enables analysis of the correspondence of sensor data with other sensor data of the scene and the immutable data store enables a forensic baseline of the sensor data to verify aspects of the trust score. Thus, for example, the tablet 145 may have captured a video of a woman crossing the street as illustrated in the scene 135. The video may show the woman being struck by the vehicle and is presented as evidence of the vehicle operator's wrongdoing. A question may be raised whether the video on the tablet 145 has been altered to make the collision look like the vehicle operator's fault rather than the woman purposefully dashing into the street. The trust score of the first sensor data, based on comparison with other sensor data, such as the second sensor data, enables a ground-truth of the scene 135 to be established. Now, the same trust score operation may be applied to the video on the tablet to determine the degree to which that video corresponds to the readings of the other sensors and establish the appropriate evidentiary considerations of the video on the tablet 145.

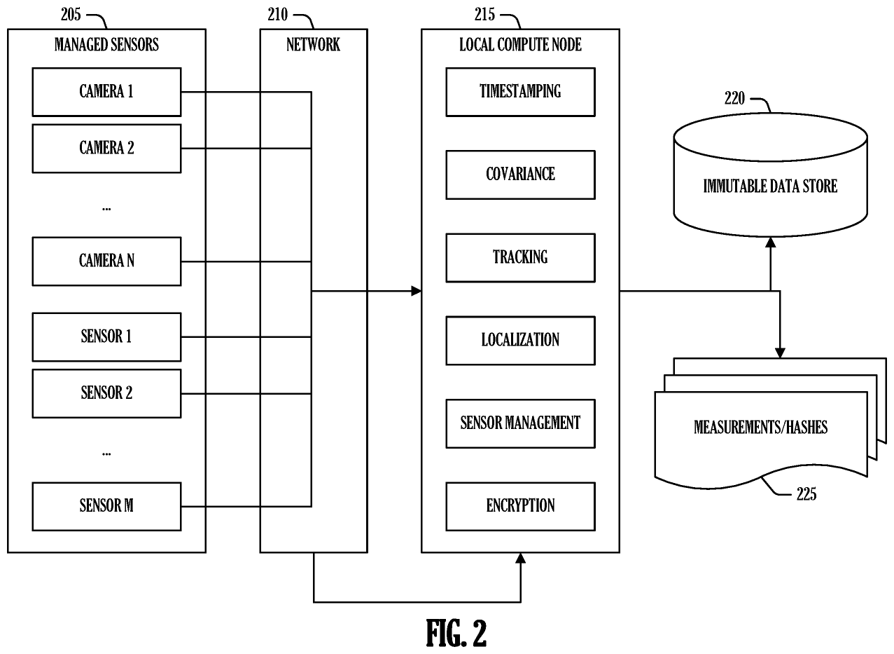

FIG. 2 illustrates an example of a data flow to capture data from sensors, according to an embodiment. The illustrated system gathers data from sensors 205 (e.g., cameras) that are provisioned and managed by a trusted entity, such as an enterprise or a venue (e.g., stadium, building, etc.) manager. All available data from sensors 205, which may be multimodal (e.g., cameras, IR, lidar, radar, thermometer, microphone, etc.) is communicated through a network 210 into a local compute node 215. The local compute node 215 is configured to collect the data into an immutable data store 220. The immutable data store 220 represents the history of the scene captured by the sensors 205. In an example, the local compute node 215 is configured to manage the sensor data, including performing data collection, data timestamping, or data encryption. In an example, the local compute node 215 is configured to track individual people or objects. In an example, the local compute node is configured to localizing sensor data, such as camera frames, in the three dimensional space of a scene.

In an example, the immutable data store 220 employs encryption, hashing, blockchain, or tagging capabilities to maintain a chain of trust back to the sensors 205 that produced the data if possible, or to the local compute node 215 otherwise. In an example, these operations are performed within a secure environment (such as a Trusted Execution Environment (TEE) with a secure enclave). In an example, the provenance of the secure environment is to be tracked within the immutable data store 220 to improve the trust of the initial ground truth dataset.

In an example, an initial trust score may be calculated or applied to the sensor data by the local compute node 215 based on the available data, encryption levels, compute trustworthiness, or network telemetry. For example, monitoring packet or network latency from a given camera feed and generating corresponding timestamps enables the local compute node 215 to establish a latency baseline for a given sensor, changes to which may result in a lower trust score. In an example, a camera feed that is normally localized but suddenly fails localization may likewise result in a reduced trust score.

In an example, the collection of data may be time sliced, measured, and hashed (measurements or hashes 225), with corresponding measurements stored in separate encrypted enclaves, for example, in the immutable data store 220. In an example, AI models may be trained using the data to enable the local compute node 215 to gauge the validity of data represented to be sourced from the same scene and time period. Thus, verification that the immutable data store 220 has not been tampered with during future analysis may be verified.

Generally, such an on-line, real time, or similar processing arrangement benefits from being physically located close to the sensors 205. Thus, it is often beneficial for the local compute node 215 to operate at the edge of the network 210 to maintain sensor data and compute integrity. If the sensors 205 are directly connected to the local compute node 215, then custodianship of the sensor data may be performed with connectivity to the network 210 and without possible interferences from any other network or compute nodes that are not managed by a fully trusted entity. Generally, it may be assumed that the ground truth trust vector is most reliable when the immutable data store 220 contains data that is generated entirely on-premises with the sensors 205 and the local compute node 215; trust values generally decreasing as more devices or networks are traversed by the sensor data.

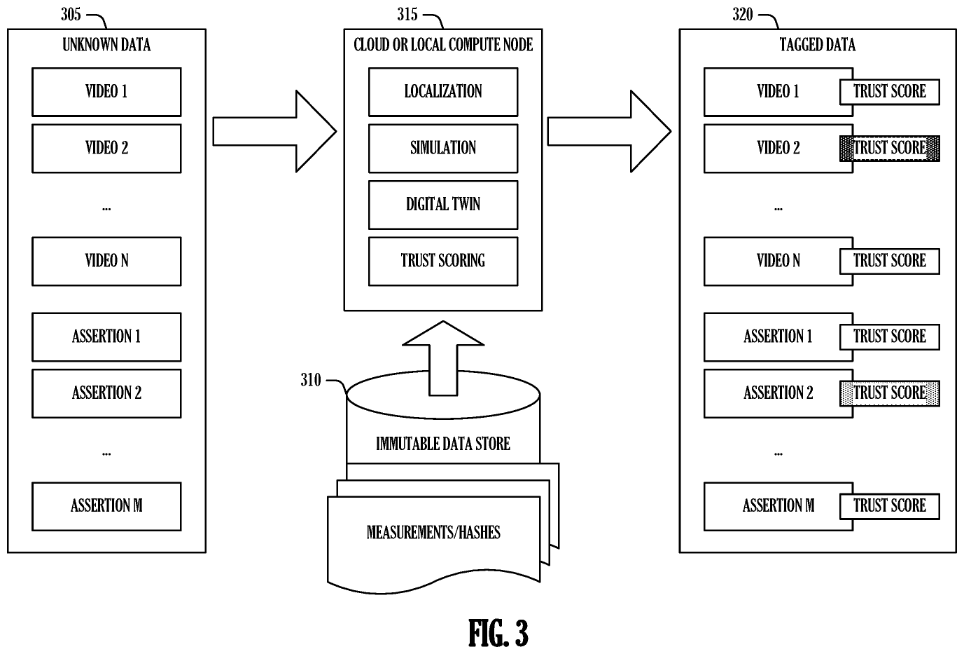

FIG. 3 illustrates an example of a data flow to establish a trust score 320 for data captured from a sensor (e.g., trust tagged data), according to an embodiment. This data flow generally covers the use of trust vectors to verify other sensor data that may include counterfeit information. In offline use (e.g., not directly connected to data acquisition from sensors), the illustrated system may be used to verify claims made by an untrusted third party against the immutable historic data stored in the immutable data store 310. The system is embodied in compute 315 that may operate in a cloud configuration or in local compute nodes, or in various other compute node combinations. In an example, the immutable data store 310 or the operations for providing trust scores may be hosted in a trusted environment (e.g., secure enclave). The operations may also include forensic accounting (e.g., as is often provided in blockchain implementations, other public ledger systems, verifiable certificates, etc.) to provide a high degree of transparency in the process. In an example, the compute 315 may be operated by a neutral third party to the first party with the unknown (e.g., unverified) data 305 and the party that produced the sensor data. For example, a video that claims to have been taken from an event showing a politician's public gaffe may be compared with a historic record of the event. The video may then be flagged with a trust score based on the available historical data by, for example, a media company.

Several techniques may be used to compare different sensor datasets. For example, timestamps may be compared to determine whether the datasets even overlap. The compute 315 may be configured to localize video or use a digital model of the venue or event to simulate video or audio data from a perspective of the unknown data 305 at the same location and time that the unknown data 305 was captured. Generally, high concordance with the measurements in the unknown data 305 and the simulation results in a higher trust score 320 for the associated sensor values. In an example, deep learning inferencing or generative AI models trained with the trusted dataset and scene may also be employed to produce some or all of the trust score 320 for the unknown data 305.

The trust score 320 may change over time. The trust score 320 may also be calculated from many factors or bases of trust, possibly using various modalities (e.g., both audio and video). The resultant vector of the trust score 320 thus operates to preserve the truth over time for given digital sensor data, making a claim to history. In the previous example of a politician's supposed gaffe, much of the video may match the actual event but the gaffe itself was maliciously generated over only a few frames. The automated and high-resolution nature of the trust score 320 enables detection of such malfeasance that may otherwise be impractical or impossible.

While it may be useful to calculate a single trust score 320 as a scalar value—such as from 0 (e.g., untrusted) to 1 (e.g., trusted)—in practice the trust score 320 may be more effective as a multi-variable vector that is a function of time for the given sensor data. In an example, the trust score 320 may be transformed (e.g., distilled) into a single scalar value using statistical techniques, such as computing the standard deviation, the maximum, the minimum, root mean square (RMS), etc.).

In an example, sensor data with a high trust score 320 may be stored in the immutable data store 310. Generally, however, such trust scores cannot be higher than the trust scores for data already stored in the immutable data store 310 as sensor data that was known a priori. This happens when the time between trust score computation and sensor data capture factors strongly into an originally computed trust score for the sensor data.

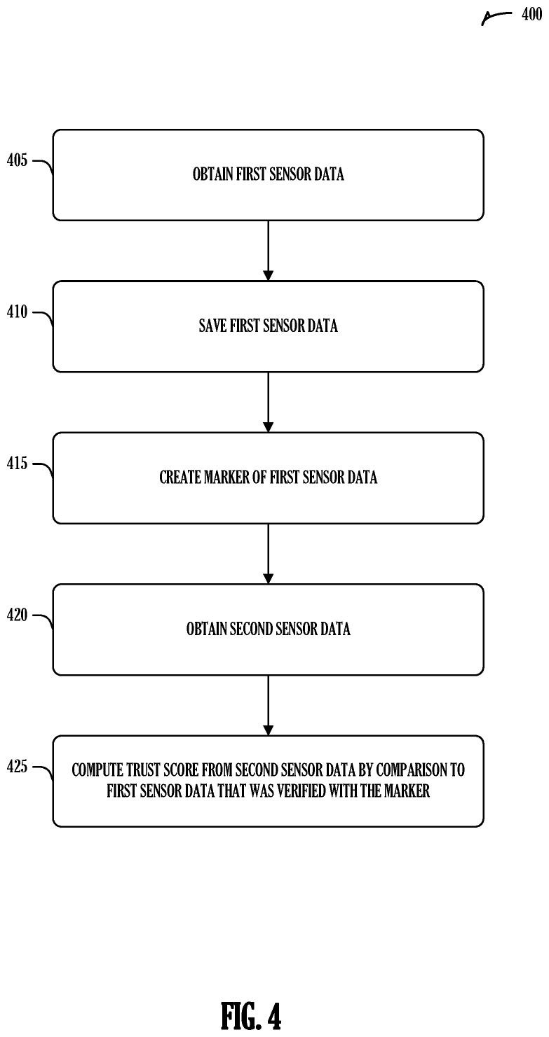

FIG. 4 illustrates a flow diagram of an example of a method 400 for sensor data verification, according to an embodiment. The operations of the method 400 are performed by computational hardware, such as that described above or below (e.g., processing circuitry).

At operation 405, a communication with first sensor data from a sensor is received (e.g., at a device). Here, a portion of the first sensor data pertains to a scene. In an example, the scene is defined by space and time. In an example, space is defined by physical dimensions of a subject In an example, an aspect of the subject is measured by the first sensor data. In an example, space is as a subset of the first sensor data. In an example, the subset of the first sensor data is part of an image or a frequency band of audio or radio signals.

At operation 410, the portion of the first sensor data is recorded in a data store. In an example, the data store is an immutable data store. In an example, the immutable data store uses a blockchain to enforce immutability. In an example, entries in the data store are encrypted.

At operation 415, a marker of the portion of the first sensor data is created by hashing a measurement of the portion of the first sensor data. In an example, the portion of the first sensor data is determined by the time. In this example, the first sensor data is sliced based on the time to produce the portion of the first sensor data. In an example, the marker is an entry in a vector; other entries in the vector being other markers created from other portions of other sensor data that correspond to the space and the time.

At operation 420, second sensor data pertaining to the scene is received. In an example, the second sensor data is captured at the device. In an example, the device records the second sensor data in the immutable data store. In an example, a second marker of the second sensor data is produced.

At operation 425, a trust score-computed for the second sensor data by comparing the second sensor data to the portion of the first sensor data stored in the data store—is provided (e.g., communicated, transmitted, held, etc.). In an example, computation of the trust score includes a verification of the portion of the first sensor data in the data store based on the marker of the portion of the first sensor data. In an example, the computation of the trust score also includes a previous trust score computed for the portion of the first sensor data. In an example, the previous trust score is based on a context of the device upon receipt of the first sensor data. In an example, the context is at least one of time or distance between creation of the first sensor data by the sensor and the device. In an example, the context includes other sensor data received by the device from other sensors that pertain to the scene.

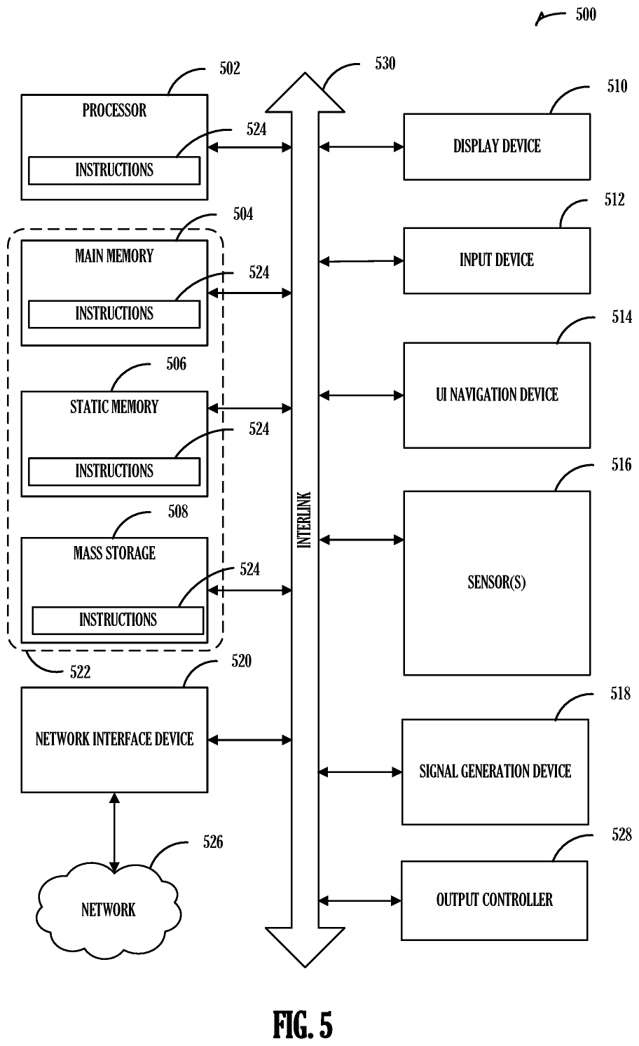

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for sensor data verification, the apparatus comprising: a memory including instructions; and processing circuitry that, when in operation, is configured by the instructions to: receive a communication that includes first sensor data from a sensor, a portion of the first sensor data pertaining to a scene; record the portion of the first sensor data in a data store; create a marker of the portion of the first sensor data by hashing a measurement of the portion of the first sensor data; receive second sensor data pertaining to the scene; and communicate a trust score computed for the second sensor data by comparing the second sensor data to the portion of the first sensor data stored in the data store, computation of the trust score including a verification of the portion of the first sensor data in the data store based on the marker of the portion of the first sensor data.
In Example 2, the subject matter of Example 1, wherein computation of the trust score also includes a previous trust score computed for the portion of the first sensor data.
In Example 3, the subject matter of Example 2, wherein the previous trust score is based on a context of the apparatus upon receipt of the first sensor data.
In Example 4, the subject matter of Example 3, wherein the context is at least one of time or distance between creation of the first sensor data by the sensor and the apparatus.
In Example 5, the subject matter of any of Examples 3-4, wherein the context includes other sensor data received by the apparatus from other sensors that pertain to the scene.
In Example 6, the subject matter of any of Examples 1-5, wherein the scene is defined by space and time.
In Example 7, the subject matter of Example 6, wherein space is defined by physical dimensions of a subject, an aspect of the subject being measured by the first sensor data.
In Example 8, the subject matter of any of Examples 6-7, wherein space is as a subset of the first sensor data.
In Example 9, the subject matter of Example 8, wherein the subset of the first sensor data is part of an image or a frequency band of audio or radio signals.
In Example 10, the subject matter of any of Examples 6-9, wherein the portion of the first sensor data is determined by the time, the first sensor data being sliced based on the time to produce the portion of the first sensor data.
In Example 11, the subject matter of Example 10, wherein the marker is an entry in a vector, other entries in the vector being other markers created from other portions of other sensor data that correspond to the space and the time.
In Example 12, the subject matter of any of Examples 1-11, wherein the data store is an immutable data store.
In Example 13, the subject matter of Example 12, wherein the immutable data store uses a blockchain to enforce immutability.
In Example 14, the subject matter of any of Examples 1-13, wherein entries in the data store are encrypted.
In Example 15, the subject matter of any of Examples 1-14, wherein the second sensor data is captured at the apparatus, the apparatus recording the second sensor data in the data store and producing a second marker of the second sensor data.
Example 16 is a method for sensor data verification, the method comprising: receiving, at a device, a communication that includes first sensor data from a sensor, a portion of the first sensor data pertaining to a scene; recording the portion of the first sensor data in a data store; creating a marker of the portion of the first sensor data by hashing a measurement of the portion of the first sensor data; receiving second sensor data pertaining to the scene; and communicating a trust score computed for the second sensor data by comparing the second sensor data to the portion of the first sensor data stored in the data store, computation of the trust score including a verification of the portion of the first sensor data in the data store based on the marker of the portion of the first sensor data.
In Example 17, the subject matter of Example 16, wherein computation of the trust score also includes a previous trust score computed for the portion of the first sensor data.
In Example 18, the subject matter of Example 17, wherein the previous trust score is based on a context of the device upon receipt of the first sensor data.
In Example 19, the subject matter of Example 18, wherein the context is at least one of time or distance between creation of the first sensor data by the sensor and the device.
In Example 20, the subject matter of any of Examples 18-19, wherein the context includes other sensor data received by the device from other sensors that pertain to the scene.
In Example 21, the subject matter of any of Examples 16-20, wherein the scene is defined by space and time.
In Example 22, the subject matter of Example 21, wherein space is defined by physical dimensions of a subject, an aspect of the subject being measured by the first sensor data.
In Example 23, the subject matter of any of Examples 21-22, wherein space is as a subset of the first sensor data.
In Example 24, the subject matter of Example 23, wherein the subset of the first sensor data is part of an image or a frequency band of audio or radio signals.
In Example 25, the subject matter of any of Examples 21-24, wherein the portion of the first sensor data is determined by the time, the first sensor data being sliced based on the time to produce the portion of the first sensor data.
In Example 26, the subject matter of Example 25, wherein the marker is an entry in a vector, other entries in the vector being other markers created from other portions of other sensor data that correspond to the space and the time.
In Example 27, the subject matter of any of Examples 16-26, wherein the data store is an immutable data store.
In Example 28, the subject matter of Example 27, wherein the immutable data store uses a blockchain to enforce immutability.
In Example 29, the subject matter of any of Examples 16-28, wherein entries in the data store are encrypted.
In Example 30, the subject matter of any of Examples 16-29, wherein the second sensor data is captured at the device, the device recording the second sensor data in the data store and producing a second marker of the second sensor data.
Example 31 is at least one machine readable medium including instructions for sensor data verification, the instructions, when executed by processing circuitry, cause the processing circuitry to perform operations comprising: receiving, at a device, a communication that includes first sensor data from a sensor, a portion of the first sensor data pertaining to a scene; recording the portion of the first sensor data in a data store; creating a marker of the portion of the first sensor data by hashing a measurement of the portion of the first sensor data; receiving second sensor data pertaining to the scene; and communicating a trust score computed for the second sensor data by comparing the second sensor data to the portion of the first sensor data stored in the data store, computation of the trust score including a verification of the portion of the first sensor data in the data store based on the marker of the portion of the first sensor data.
In Example 32, the subject matter of Example 31, wherein computation of the trust score also includes a previous trust score computed for the portion of the first sensor data.
In Example 33, the subject matter of Example 32, wherein the previous trust score is based on a context of the device upon receipt of the first sensor data.
In Example 34, the subject matter of Example 33, wherein the context is at least one of time or distance between creation of the first sensor data by the sensor and the device.
In Example 35, the subject matter of any of Examples 33-34, wherein the context includes other sensor data received by the device from other sensors that pertain to the scene.
In Example 36, the subject matter of any of Examples 31-35, wherein the scene is defined by space and time.
In Example 37, the subject matter of Example 36, wherein space is defined by physical dimensions of a subject, an aspect of the subject being measured by the first sensor data.
In Example 38, the subject matter of any of Examples 36-37, wherein space is as a subset of the first sensor data.
In Example 39, the subject matter of Example 38, wherein the subset of the first sensor data is part of an image or a frequency band of audio or radio signals.
In Example 40, the subject matter of any of Examples 36-39, wherein the portion of the first sensor data is determined by the time, the first sensor data being sliced based on the time to produce the portion of the first sensor data.
In Example 41, the subject matter of Example 40, wherein the marker is an entry in a vector, other entries in the vector being other markers created from other portions of other sensor data that correspond to the space and the time.
In Example 42, the subject matter of any of Examples 31-41, wherein the data store is an immutable data store.
In Example 43, the subject matter of Example 42, wherein the immutable data store uses a blockchain to enforce immutability.
In Example 44, the subject matter of any of Examples 31-43, wherein entries in the data store are encrypted.
In Example 45, the subject matter of any of Examples 31-44, wherein the second sensor data is captured at the device, the device recording the second sensor data in the data store and producing a second marker of the second sensor data.
Example 46 is a system for sensor data verification, the system comprising: means for receiving, at a device of the system, a communication that includes first sensor data from a sensor, a portion of the first sensor data pertaining to a scene; means for recording the portion of the first sensor data in a data store; means for creating a marker of the portion of the first sensor data by hashing a measurement of the portion of the first sensor data; means for receiving second sensor data pertaining to the scene; and means for communicating a trust score computed for the second sensor data by comparing the second sensor data to the portion of the first sensor data stored in the data store, computation of the trust score including a verification of the portion of the first sensor data in the data store based on the marker of the portion of the first sensor data.
In Example 47, the subject matter of Example 46, wherein computation of the trust score also includes a previous trust score computed for the portion of the first sensor data.
In Example 48, the subject matter of Example 47, wherein the previous trust score is based on a context of the device upon receipt of the first sensor data.
In Example 49, the subject matter of Example 48, wherein the context is at least one of time or distance between creation of the first sensor data by the sensor and the device.
In Example 50, the subject matter of any of Examples 48-49, wherein the context includes other sensor data received by the device from other sensors that pertain to the scene.
In Example 51, the subject matter of any of Examples 46-50, wherein the scene is defined by space and time.
In Example 52, the subject matter of Example 51, wherein space is defined by physical dimensions of a subject, an aspect of the subject being measured by the first sensor data.
In Example 53, the subject matter of any of Examples 51-52, wherein space is as a subset of the first sensor data.
In Example 54, the subject matter of Example 53, wherein the subset of the first sensor data is part of an image or a frequency band of audio or radio signals.
In Example 55, the subject matter of any of Examples 51-54, wherein the portion of the first sensor data is determined by the time, the first sensor data being sliced based on the time to produce the portion of the first sensor data.
In Example 56, the subject matter of Example 55, wherein the marker is an entry in a vector, other entries in the vector being other markers created from other portions of other sensor data that correspond to the space and the time.
In Example 57, the subject matter of any of Examples 46-56, wherein the data store is an immutable data store.
In Example 58, the subject matter of Example 57, wherein the immutable data store uses a blockchain to enforce immutability.
In Example 59, the subject matter of any of Examples 46-58, wherein entries in the data store are encrypted.
In Example 60, the subject matter of any of Examples 46-59, wherein the second sensor data is captured at the device, the device recording the second sensor data in the data store and producing a second marker of the second sensor data.
Example 61 is at least one machine-readable medium including instructions that, when executed by processing circuitry, cause the processing circuitry to perform operations to implement of any of Examples 1-60.
Example 62 is an apparatus comprising means to implement of any of Examples 1-60.
Example 63 is a system to implement of any of Examples 1-60.
Example 64 is a method to implement of any of Examples 1-60.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for sensor data verification, the apparatus comprising:
a memory including instructions; and
processing circuitry that, when in operation, is configured by the instructions to:
receive a communication that includes first sensor data from a sensor, a portion of the first sensor data pertaining to a scene;
create a marker of the portion of the first sensor data by hashing a measurement of the portion of the first sensor data;
receive second sensor data pertaining to the scene; and
communicate a trust score computed for the second sensor data by comparing the second sensor data to the portion of the first sensor data, wherein the trust score is determined on a verification of the portion of the first sensor data based on the marker of the portion of the first sensor data.

2. The apparatus of claim 1, wherein the trust score is determined from a previous trust score computed for the portion of the first sensor data.

3. The apparatus of claim 2, wherein the previous trust score is determined based on a context of the apparatus upon receipt of the first sensor data.

4. The apparatus of claim 3, wherein the context is at least one of time or distance between creation of the first sensor data by the sensor and the apparatus.

5. The apparatus of claim 3, wherein the context includes other sensor data received by the apparatus from other sensors that pertain to the scene.

6. The apparatus of claim 1, wherein the scene is defined by space and time.

7. The apparatus of claim 6, wherein space is defined by physical dimensions of a subject, an aspect of the subject being measured by the first sensor data.

8. The apparatus of claim 6, wherein space is as a subset of the first sensor data.

9. The apparatus of claim 6, wherein the portion of the first sensor data is determined by the time, the first sensor data being sliced based on the time to produce the portion of the first sensor data.

10. The apparatus of claim 9, wherein the marker is an entry in a vector, other entries in the vector being other markers created from other portions of other sensor data that correspond to the space and the time.

11. At least one machine readable medium including instructions for sensor data verification, the instructions, when executed by processing circuitry, cause the processing circuitry to perform operations comprising:
receiving, at a device, a communication that includes first sensor data from a sensor, a portion of the first sensor data pertaining to a scene;
creating a marker of the portion of the first sensor data by hashing a measurement of the portion of the first sensor data;
receiving second sensor data pertaining to the scene; and
communicating a trust score computed for the second sensor data by comparing the second sensor data to the portion of the first sensor data wherein the trust score is determined on a verification of the portion of the first sensor data based on the marker of the portion of the first sensor data.

12. The at least one machine readable medium of claim 11, wherein the trust score is determined from a previous trust score computed for the portion of the first sensor data.

13. The at least one machine readable medium of claim 12, wherein the previous trust score is determined based on a context of the device upon receipt of the first sensor data.

14. The at least one machine readable medium of claim 13, wherein the context is at least one of time or distance between creation of the first sensor data by the sensor and the device.

15. The at least one machine readable medium of claim 13, wherein the context includes other sensor data received by the device from other sensors that pertain to the scene.

16. The at least one machine readable medium of claim 11, wherein the scene is defined by space and time.

17. The at least one machine readable medium of claim 16, wherein space is defined by physical dimensions of a subject, an aspect of the subject being measured by the first sensor data.

18. The at least one machine readable medium of claim 16, wherein space is as a subset of the first sensor data.

19. The at least one machine readable medium of claim 16, wherein the portion of the first sensor data is determined by the time, the first sensor data being sliced based on the time to produce the portion of the first sensor data.

20. The at least one machine readable medium of claim 19, wherein the marker is an entry in a vector, other entries in the vector being other markers created from other portions of other sensor data that correspond to the space and the time.
